(19) United States
(12) Patent Application Publication
(10) Pub. No.: US 2022/0281486 A1
(43) Pub. Date: Sep. 8, 2022

(54) AUTOMATED DRIVING VEHICLE, VEHICLE ALLOCATION MANAGEMENT DEVICE, AND TERMINAL DEVICE

(71) Applicant: TOYOTA JIDOSHA KABUSHIKI KAISHA, Aichi-ken (JP)

(72) Inventors: Shin SAKURADA, Toyota-shi (JP); Katsuya HOSHI, Nisshin-shi (JP); Hiroaki SUGIYAMA, Nagoya-shi (JP); Masahisa SAWADA, Nagoya-shi (JP); Hiroyuki ITO, Kariya-shi (JP); Makoto SEGI, Kariya-shi (JP); Hiroki HATTORI, Kariya-shi (JP)

(21) Appl. No.: 17/564,220

(22) Filed: Dec. 29, 2021

(30) Foreign Application Priority Data
Mar. 5, 2021 (JP) 2021-034980

(51) Int. Cl. B60W 60/00; G06V 20/56; G06V 40/16; G06Q 10/02; G06Q 50/30

(52) U.S. Cl. CPC B60W 60/00253; G06V 20/56; G06V 40/16; G06Q 10/02; G06Q 50/30; B60W 2420/42; B60W 2556/45

(57) ABSTRACT

An automated driving vehicle includes an analysis unit, an autonomous travel control unit, and a passenger ascertaining unit configured to transmit a notification to an interested person's contact-number device set in a reservation for vehicle allocation in at least one of (1) a case in which a passenger set in the reservation for vehicle allocation has boarded at a boarding point set in the reservation for vehicle allocation, (2) a case in which the passenger has not been recognized by the analysis unit within a predetermined waiting time from a target boarding point arrival time set in the reservation for vehicle allocation, and (3) a case in which the passenger has alighted at a destination set in the reservation for vehicle allocation.

### CROSS-REFERENCE TO RELATED APPLICATION

This application claims priority to Japanese Patent Application No. 2021-034980 filed on Mar. 5, 2021, incorporated herein by reference in its entirety.

### BACKGROUND

### 1. Technical Field

The present disclosure relates to an automated driving vehicle that is used as an unmanned taxi, a vehicle allocation management device that manages vehicle allocation in an unmanned taxi service, and a terminal device that can make a reservation for vehicle allocation.

### 2. Description of Related Art

For example, as described in Japanese Unexamined Patent Application Publication No. 2016-210417 (JP 2016-210417 A), an automated driving vehicle which does not require a driver's driving and which can operate autonomously is known.

In Japanese Unexamined Patent Application Publication No. 2005-56135 (JP 2005-56135 A), effective utilization of a pickup vehicle which is owned by a nursing care service provider is achieved by using the pickup vehicle as a care taxi when the pickup vehicle and a driver thereof are unoccupied. Japanese Unexamined Patent Application Publication No. 2016-162438 (JP 2016-162438 A) discloses a pickup service based on vehicle sharing in which a vehicle with a driver is shared for aged persons.

### SUMMARY

The present disclosure provides an automated driving vehicle, a vehicle allocation management device, and a terminal device that can remotely watch a passenger when providing an unmanned taxi service using an automated driving vehicle.

An automated driving vehicle according to an aspect of the present disclosure includes an analysis unit, an automatic travel control unit, and a passenger ascertaining unit. The analysis unit is configured to be able to perform attribute recognition and distance measurement of a nearby object of a host vehicle. The autonomous travel control unit is configured to be able to autonomously control a steering mechanism, a brake mechanism, and a drive mechanism based on predetermined travel route information and the attributes and distance of the nearby object. The passenger ascertaining unit is configured to transmit a notification to an interested person's contact-number device set in a reservation for vehicle allocation in at least one of (1) a case in which a passenger set in the reservation for vehicle allocation has boarded at a boarding point set in the reservation for vehicle allocation, (2) a case in which the passenger has not been recognized by the analysis unit within a predetermined waiting time from a target boarding point arrival time set in the reservation for vehicle allocation, and (3) a case in which the passenger has alighted at a destination set in the reservation for vehicle allocation.

With this configuration, information of boarding/alighting of a passenger and information of absence of a passenger at the time of boarding is transmitted to an interested person's contact-number device. For example, when the passenger is an aged person or a child, the information is transmitted to a contact number of a family member thereof and thus the family member can ascertain the passenger.

In the configuration, the automated driving vehicle may further include an imaging device that images the periphery of the automated driving vehicle and transmits a captured image to the analysis unit. In this case, the passenger ascertaining unit may be configured to transmit an absence notification as the notification to the interested person's contact-number device and to transmit the captured image in (2) the case in which the passenger has not been recognized by the analysis unit within the predetermined waiting time from the target boarding point arrival time. The imaging device may be configured to change imaging settings based on an operation command from the interested person's contact-number device having received the absence notification.

With this configuration, when the automated driving vehicle cannot recognize a passenger even after the target boarding point arrival time, the interested person's contact-number device can see an image captured by the imaging device of the automated driving vehicle and remotely operate the imaging device. Accordingly, a remote interested person can ascertain, for example, features of the passenger which the automated driving vehicle has difficulty recognizing using the captured image, and the imaging settings of the imaging device can be changed by a remote operation in order to ascertain features which can be easily recognized such as a face of the passenger.

In the configuration, the analysis unit may be configured to recognize the passenger in the captured image based on a face image of the passenger set in the reservation for vehicle allocation.

With this configuration, it is possible to save labor of the passenger inputting a password to a device mounted in the automated driving vehicle, or the like.

In the configuration, the automated driving vehicle may further include an outside speaker that is able to output voice which is input to a calling unit of the interested person's contact-number device.

With this configuration, it is possible attract attention of a passenger who is not conscious of the automated driving vehicle by outputting the interested person's voice from the outside speaker.

A vehicle allocation management device according to another aspect of the present disclosure includes: a vehicle allocation managing unit and a passenger ascertaining unit. The vehicle allocating managing unit is configured to allocate an automated driving vehicle to a boarding point set in a reservation for vehicle allocation at the time of pickup based on the reservation for vehicle allocation. The passenger ascertaining unit is configured to transmit a notification to an interested person's contact-number device set in a reservation for vehicle allocation in at least one of (1) a case in which a passenger set in the reservation for vehicle allocation has boarded the automated driving vehicle at the boarding point, (2) a case in which the passenger has not been recognized by the automated driving vehicle within a predetermined waiting time from a target boarding point arrival time set in the reservation for vehicle allocation, and (3) a case in which the passenger has alighted from the automated driving vehicle at a destination set in the reservation for vehicle allocation.

In the configuration, the passenger ascertaining unit may be configured to transmit an absence notification as the notification to the interested person's contact-number device and to transmit an image captured by an imaging device configured to image the periphery of the automated driving vehicle in (2) the case in which the passenger has not been recognized by the automated driving vehicle within the predetermined waiting time from the target boarding point arrival time. The absence notification may include a message for demanding an input of an operation command for the imaging device from the interested person's contact-number device.

A terminal device according to another aspect of the present disclosure includes an input unit configured to be able to receive an input of a reservation for vehicle allocation of an automated driving vehicle. A boarding point, a target boarding point arrival time, and a passenger are set in the reservation for vehicle allocation. The terminal device further includes a transceiver unit and a remote operation unit. The transceiver unit is configured to receive an absence notification and an image captured by an imaging device configured to image the periphery of the automated driving vehicle when the passenger has not been recognized at the boarding point by the automated driving vehicle within a predetermined waiting time from the target boarding point arrival time. The remote operation unit is configured to be able to input an operation command for the imaging device when the absence notification and the captured image are received by the transceiver unit.

With the automated driving vehicle, the vehicle allocation management device, and the terminal device according to the present disclosure, it is possible to remotely watch a passenger when providing an unmanned taxi service using an automated driving vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a hardware configuration of a vehicle allocation system according to an embodiment;

FIG. 2 is a diagram illustrating a functional configuration of the vehicle allocation system according to the embodiment;

FIG. 3 is a diagram illustrating a user registration information management table;

FIG. 4 is a diagram illustrating a vehicle allocation reservation information management table;

FIG. 5 is a perspective view illustrating personal mobility as an example of an automated driving vehicle according to the embodiment;

FIG. 6 is a diagram illustrating a vehicle allocation routine which is performed by a vehicle allocation management device;

FIG. 7 is a diagram illustrating a pickup routine (1/2) after departure arrangement;

FIG. 8 is a diagram illustrating a pickup routine (2/2) after departure arrangement;

FIG. 9 is a diagram illustrating a guidance screen (1/6) which is displayed on a display unit of a terminal device at the time of pickup;

FIG. 10 is a diagram illustrating a guidance screen (2/6) which is displayed on a display unit of a terminal device at the time of pickup;

FIG. 11 is a diagram illustrating a guidance screen (3/6) which is displayed on a display unit of a terminal device at the time of pickup;

FIG. 12 is a diagram illustrating a guidance screen (4/6) which is displayed on a display unit of a terminal device at the time of pickup;

FIG. 13 is a diagram illustrating a guidance screen (5/6) which is displayed on a display unit of a terminal device at the time of pickup;

FIG. 14 is a diagram illustrating a remote operation screen of an imaging device which is displayed on a display unit of a terminal device at the time of pickup;

FIG. 15 is a diagram illustrating a guidance screen (6/6) which is displayed on a display unit of a terminal device at the time of pickup;

FIG. 16 is a diagram illustrating a functional configuration of a vehicle allocation system according to another example of the embodiment;

FIG. 17 is a diagram illustrating a pickup routine (1/2) after departure arrangement according to another embodiment of the embodiment; and

FIG. 18 is a diagram illustrating a pickup routine (2/2) after departure arrangement according to another embodiment of the embodiment.

### DETAILED DESCRIPTION OF EMBODIMENTS

Hereinafter, an embodiment of the disclosure will be described with reference to the accompanying drawings. Shapes, materials, numbers, and numerical values which will be described below are merely provided for description, and can be appropriately changed according to specifications of an automated driving vehicle, a vehicle allocation management device, and a terminal device. In the following description, the same or similar elements in all the drawings will be referred to by the same reference signs.

### Overall Configuration

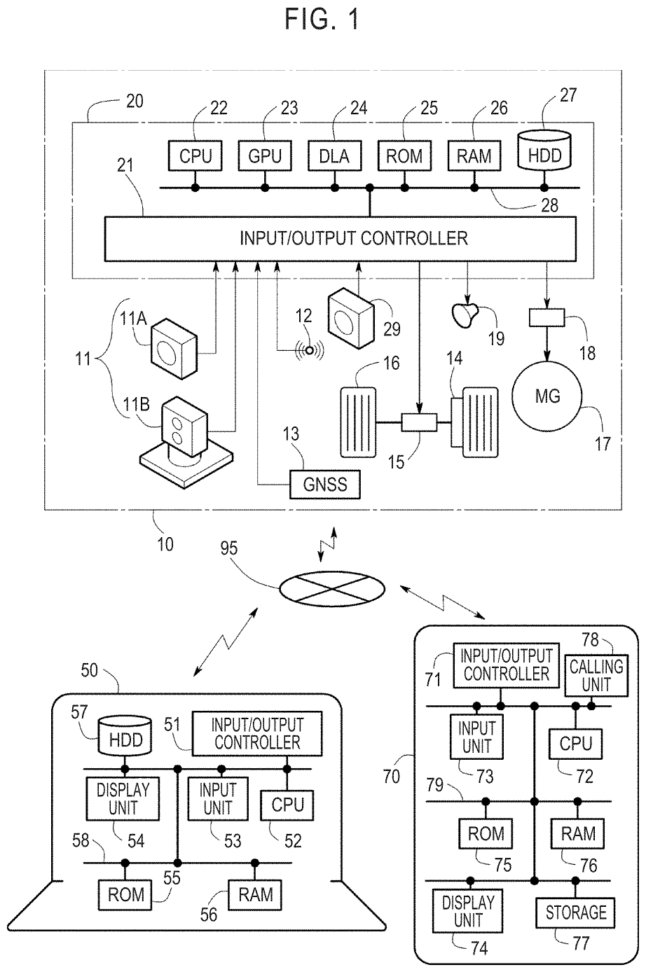

FIG. 1 illustrates the overall configuration of a vehicle allocation system according to an embodiment. This system includes an automated driving vehicle 10, a vehicle allocation management device 50, and a terminal device 70. The automated driving vehicle 10, the vehicle allocation management device 50, and the terminal device 70 are able to communicate with each other using a communication means such as the Internet 95.

In the vehicle allocation system according to this embodiment, a user who is an owner of a terminal device 70 such as a smartphone makes a reservation for allocation of an automated driving vehicle 10 which is an unmanned taxi. The vehicle allocation management device 50 performs reception of a reservation for vehicle allocation and management of the automated driving vehicle 10.

In the vehicle allocation system according to this embodiment, a person other than a user of a terminal device 70 which has made a reservation for vehicle allocation is supposed as a main passenger. For example, an aged person or a child is a passenger and a family member thereof makes a reservation for vehicle allocation using his or her terminal device 70.

As will be described below in detail, in the vehicle allocation system according to this embodiment, an automated driving vehicle 10 which is an unmanned taxi travels to a boarding point which is set in a reservation for vehicle allocation at the time of pickup. When the automated driving vehicle 10 arrives at the boarding point, the automated driving vehicle 10 images the periphery of the automated driving vehicle and recognizes a passenger.

When the recognized passenger boards the automated driving vehicle 10 and departs, a boarding notification is transmitted to an interested person's contact-number device including the terminal device 70 having made the reservation for vehicle allocation. When the automated driving vehicle 10 with the passenger therein arrives at a destination and the passenger alights, an alighting notification is transmitted to the interested person's contact-number device. In this way, the remote interested person can be notified that the passenger has boarded or alighted and thus watch the passenger.

In the vehicle allocation system according to this embodiment, when the automated driving vehicle 10 cannot recognize a passenger at the boarding point after a target boarding point arrival time, an absence notification and a captured image around the automated driving vehicle 10 are transmitted to the terminal device 70 which is an interested person's contact-number device. In the terminal device 70 having received the transmitted information, a user thereof remotely operates an outside camera 11A of the automated driving vehicle 10. For example, an interested person who sees the captured image can visually recognize features of the passenger which have not been set at the time of the reservation for vehicle allocation and remotely operate the outside camera 11A (for example, image enlargement of the passenger), and thus the automated driving vehicle 10 can accurately recognize the passenger.

### Vehicle Allocation Management Device

The vehicle allocation management device 50 is installed, for example, at a management company that provides an unmanned taxi service using an automated driving vehicle 10. The vehicle allocation management device 50 is constituted by, for example, a computer (an electronic calculator). Referring to FIG. 1, the vehicle allocation management device 50 includes an input/output controller 51 that controls input and output of data as a hardware configuration thereof. The vehicle allocation management device 50 also includes a CPU 52, an input unit 53, a display unit 54, a ROM 55, a RAM 56, and a hard disk drive 57 (HDD). A storage device such as a solid-state drive (SSD) may be used instead of the hard disk drive 57. These constituents are connected to an internal bus 58.

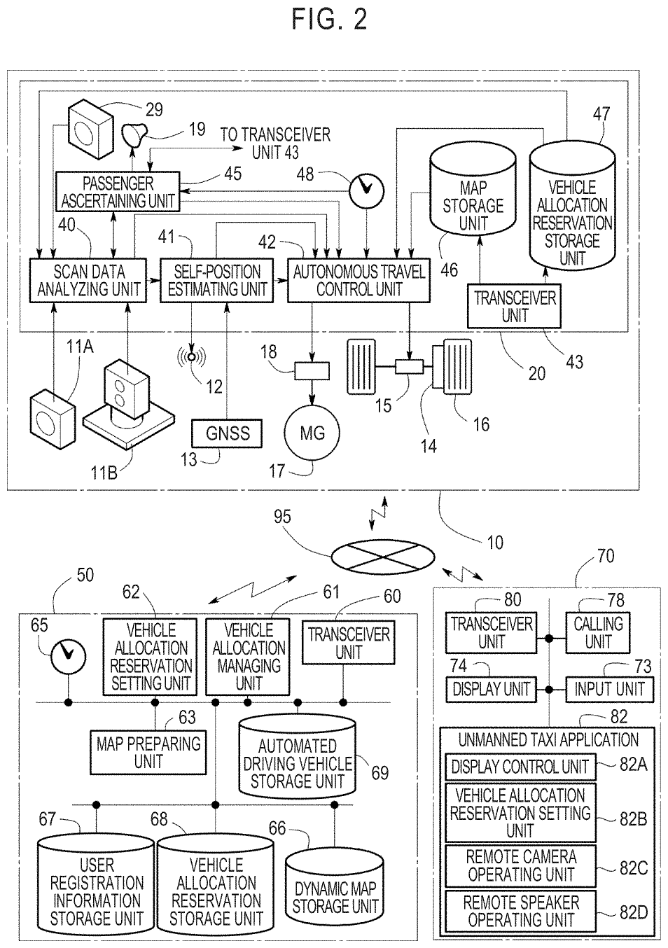

A program for performing vehicle allocation management is stored in at least one of the ROM 55 and the hard disk drive 57 which are storage devices. By causing the CPU 52 or the like of the vehicle allocation management device 50 to execute the program, functional blocks illustrated in FIG. 2 are formed in the vehicle allocation management device 50.

That is, the vehicle allocation management device 50 includes a dynamic map storage unit 66, a user registration information storage unit 67, a vehicle allocation reservation storage unit 68, and an automated driving vehicle storage unit 69 as storage units. The vehicle allocation management device 50 includes a transceiver unit 60, a vehicle allocation managing unit 61, a vehicle allocation reservation setting unit 62, a map preparing unit 63, and a timepiece 65 as functional units.

Dynamic map data which is map data is stored in the dynamic map storage unit 66. A dynamic map is a three-dimensional map and stores, for example, a position and a shape (three-dimensional shape) of a road. The three-dimensional shape of a road includes, for example, gradients and widths. Positions of lanes, crosswalks, stop lines, and the like which are drawn on a road are also stored in the dynamic map. Positions and shapes (three-dimensional shapes) of structures such as buildings and signals near a road are also stored in the dynamic map. Positions and shapes of parking lots are also stored in the dynamic map.

For example, a geographic coordinate system including latitude and longitude is used in the dynamic map. When an automated driving vehicle 10 travels by automated driving, the map preparing unit 63 extracts dynamic map data from the dynamic map storage unit 66 and prepares guidance map data including a travel route. The travel route includes a current position of the automated driving vehicle 10, a boarding point, and a destination.

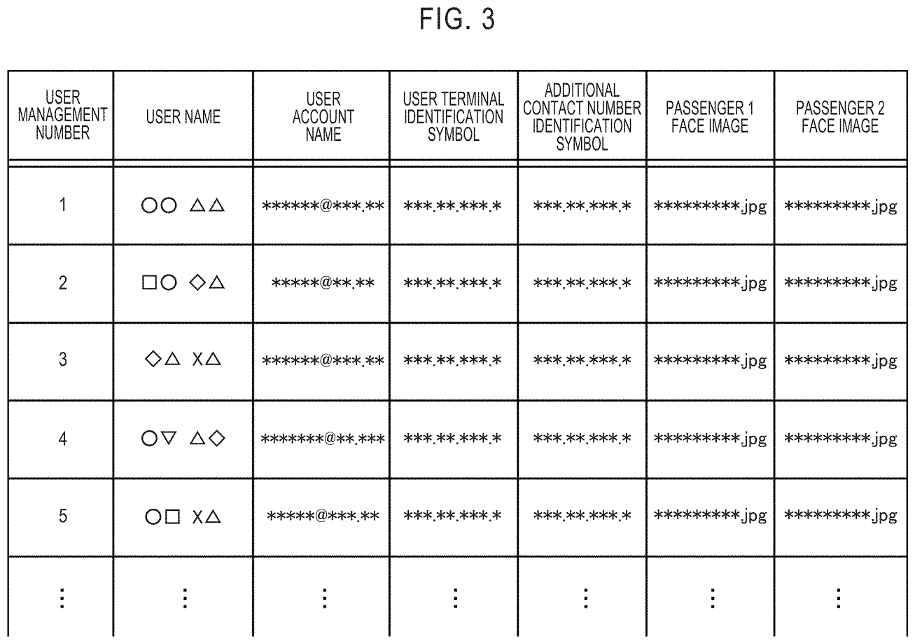

Registration information of users who are provided with an unmanned taxi service using automated driving vehicles 10 is stored in the user registration information storage unit 67. FIG. 3 illustrates a user registration information management table which is stored in the user registration information storage unit 67.

Entries of a user management number, a user name, a user account name, a user terminal identification symbol, an additional contact number identification symbol, and face images of passengers 1 and 2 are provided in the management table. The user account name is a name (a member name) for identifying a user who uses the unmanned taxi service using an automated driving vehicle 10 and is a name for using an unmanned taxi application 82 installed in a terminal device 70 of the user. For example, an email address of a user is used as the user account name.

The user terminal identification symbol is a symbol for identifying a terminal device 70 which is an interested person's contact-number device owned by a user over the Internet 95. The user terminal identification symbol may be, for example, an IP address which is assigned to the terminal device 70. As will be described later, when a passenger set in a reservation for vehicle allocation has boarded an automated driving vehicle 10, when the passenger has alighted from the vehicle, and when the scan data analyzing unit 40 of the automated driving vehicle 10 cannot recognize the passenger, the passenger ascertaining unit 45 accesses the terminal device 70 which is an interested person's contact-number device via the Internet 95 with reference to the user terminal identification symbol.

An identification symbol of a device that can receive a notification from the passenger ascertaining unit 45 in addition to the terminal device 70 which is a user terminal is stored in an entry of the additional contact number identification symbol. For example, when the passenger is an aged person, a smartphone which is owned by a family hospital is used as the additional device. The additional contact number identification symbol may be, for example, an IP address which is assigned to the added device.

Face image data of a passenger who uses the unmanned taxi service is stored in the entries of the face images of passengers 1 and 2. The face image data may be image data such as JPEG data. As will be described later, when a passenger boards an automated driving vehicle 10 which is an unmanned taxi, a face of the passenger is recognized based on the face image data. Because this recognition of a face is performed, a passenger does not need to operate a device for authentication, for example, when a person who is unaccustomed to an operation of an information and communication device such as a preschool child or an aged person is supposed as a passenger of the unmanned taxi.

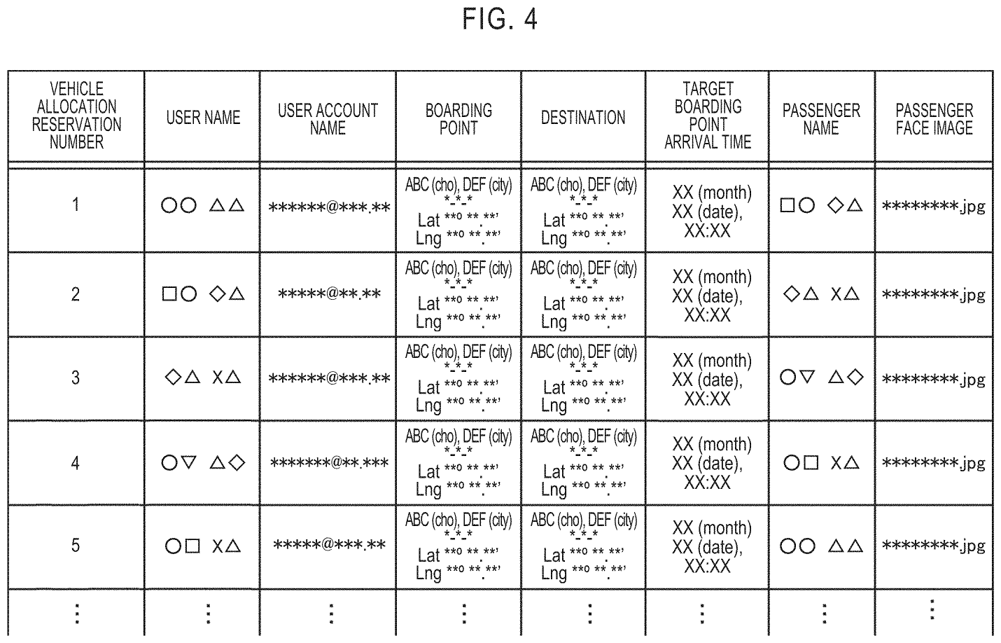

A vehicle allocation reservation information management table illustrated in FIG. 4 is stored in the vehicle allocation reservation storage unit 68. Entries of a user name, a user account name, a boarding point, a destination, a target boarding point arrival time, a passenger name, and a face image of a passenger are provided in the vehicle allocation reservation management table.

The user account name corresponds to the user account name stored in the user registration information management table illustrated in FIG. 3. That is, a user account name from when a user started the unmanned taxi application 82 at the time of making a reservation for vehicle allocation is stored in the entry. A user name correlated with the user account name is stored in the vehicle allocation reservation management table.

A boarding point and a destination which are input from the unmanned taxi application 82 are stored in the entries of the boarding point and the destination. Addresses of the boarding point and the destination are stored in these entries. Geographic coordinates (latitude and longitude) of the boarding point and the destination are also stored to cope with a coordinate system of dynamic data.

A name of a passenger of an unmanned taxi is stored in the entry of the passenger name. The passenger name is input by a user, for example, using the unmanned taxi application 82. Face image data of a passenger is stored in the entry of the passenger face image. For example, this data is selected out of face images of passengers stored in the user registration information management table illustrated in FIG. 3 by the user.

Vehicle information of an automated driving vehicle 10 which is an unmanned taxi managed by the vehicle allocation management device 50 is stored in the automated driving vehicle storage unit 69. The vehicle information includes an identification symbol (for example, a vehicle number), a vehicle color, mileage, a state of charge, an operating state (in pickup, occupied, or available), etc. of the automated driving vehicle 10.

The vehicle allocation managing unit 61 manages automated driving vehicles 10 based on a reservation for vehicle allocation. As will be described later, when a target boarding point arrival time approaches, the vehicle allocation managing unit 61 sets an automated driving vehicle 10 in an available state as an allocated vehicle. The automated driving vehicle 10 is allocated for a boarding point which is set in the reservation for vehicle allocation. The vehicle allocation reservation setting unit 62 makes a reservation for vehicle allocation of an automated driving vehicle 10 in cooperation with the unmanned taxi application 82 of the terminal device 70.

The map preparing unit 63 prepares a travel route connecting three points including a current position (that is, a departure point) of the automated driving vehicle 10 set as the allocated vehicle and a boarding point and a destination set in the reservation for vehicle allocation. The map preparing unit 63 transmits dynamic map data including the travel route to the automated driving vehicle 10 set as the allocated vehicle. At the time of reservation for vehicle allocation using the unmanned taxi application 82, the map preparing unit 63 transmits map data (for example, two-dimensional map data) to the terminal device 70.

### Automated Driving Vehicle

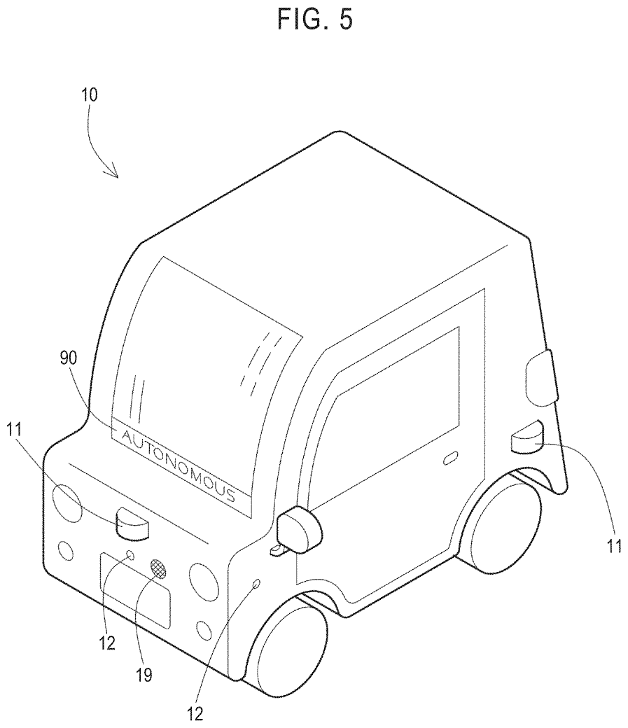

An appearance of an automated driving vehicle 10 is illustrated in FIG. 5. For example, an automated driving vehicle 10 is also referred to as personal mobility or ultra-small mobility and is a small vehicle with a capacity of one or two passengers. The automated driving vehicle 10 is used, for example, as an unmanned taxi.

An automated driving vehicle 10 can operate at level 0 (at which a driver performs all operations) to level 5 (at which driving is fully automated) based on the standard in the Society of Automotive Engineers (SAE) of the United States. For example, the level of automated driving is set to, for example, level 4 or level 5 when the automated driving vehicle 10 operates.

An automated driving mechanism of an automated driving vehicle 10 is illustrated in FIG. 1. The automated driving vehicle 10 is a motor-driven vehicle in which an electrical rotary machine 17 (a motor) is used as a drive source and a battery which is not illustrated is used as a power supply. The automated driving vehicle 10 includes a steering mechanism 15 that steers vehicle wheels 16 and a brake mechanism 14 that brakes the vehicle wheels 16 as travel control mechanisms. The automated driving vehicle 10 includes an inverter 18 that controls an output of the electrical rotary machine 17 as a drive mechanism.

The automated driving vehicle 10 includes an outside camera 11A, a LiDAR unit 11B, a proximity sensor 12, a positioning unit 13, and a control unit 20 as mechanisms for acquisition of a self-position or ascertainment of surrounding circumstances.

Referring to FIG. 5, a sensor unit 11 is provided in a front surface, a rear surface, and two side surfaces of the automated driving vehicle 10. Each sensor unit 11 includes the outside camera 11A (see FIG. 1) and the LiDAR unit 11B.

The LiDAR unit 11B is a sensor unit for travel by automated driving and is a distance measuring unit that can measure a distance between a nearby object of the host vehicle and the host vehicle. A technique of measuring a distance to a nearby object using Light Detection and Ranging (LiDAR), that is, laser light, is used in the LiDAR unit 11B. The LiDAR unit 11B includes an emitter that emits infrared laser light to the outside, a receiver that receives reflected light, and a motor that rotates the emitter and the receiver.

For example, the emitter emits infrared laser light to the outside. When laser light emitted from the emitter reaches a nearby object of the automated driving vehicle 10, reflected light thereof is received by the receiver. A distance between a reflecting point and the receiver is calculated based on a time required from emission of light from the emitter to reception of light by the receiver. When the emitter and the receiver are rotated by the motor, laser light is emitted in the horizontal direction and the vertical direction and thus three-dimensional point group data for the periphery of the automated driving vehicle 10 can be acquired.

The outside camera 11A is an imaging device that captures an image in the same field of view as the LiDAR unit 11B. The outside camera 11A includes an image sensor such as a CMOS sensor or a CCD sensor. The proximity sensor 12 is, for example, an infrared sensor and is provided on the front surface, the two side surfaces, and the rear surface of the automated driving vehicle 10 as illustrated in FIG. 5. The outside camera 11A images the periphery of the automated driving vehicle 10 and transmits the captured image to the scan data analyzing unit 40.

The positioning unit 13 is a system that performs positioning using artificial satellites and, for example, a Global Navigation Satellite System (GNSS) is used. The self-position (latitude and longitude) can be estimated using the positioning unit 13.

An inside camera 29 images the inside of the automated driving vehicle 10. The captured image is used to determine whether a passenger has boarded the automated driving vehicle. The inside camera 29 includes an image sensor such as a CMOS sensor or a CCD sensor.

An outside speaker 19 is provided on the front surface of the automated driving vehicle 10 as illustrated in FIG. 5. When the passenger ascertaining unit 45 (see FIG. 2) cannot recognize a passenger at the boarding point as will be described later, voice input to the calling unit 78 of the terminal device 70 which is an interested person's contact-number device, for example, natural voice of the interested person, is output from the outside speaker 19.

For example, an outside noticeboard 90 (see FIG. 5) is provided on the front surface of the automated driving vehicle 10. The outside noticeboard 90 is, for example, a liquid crystal display and is configured to be able to display various messages. For example, an automated driving state (AUTONOMOUS), an available state, or an occupied state is displayed on the outside noticeboard 90. A name or nickname of a passenger is displayed on the outside noticeboard 90 at the time of pickup.

Referring to FIG. 1, the control unit 20 may be, for example, an electronic control unit (ECU) of the automated driving vehicle 10 and is constituted by a computer (an electronic calculator). The control unit 20 includes an input/output controller 21 that controls input/output of data as a hardware configuration thereof. The control unit 20 includes a CPU 22, a graphics processing unit (GPU) 23, and a deep learning accelerator (DLA) 24 as arithmetic units. The control unit 20 includes a ROM 25, a RAM 26, and a hard disk drive (HDD) 27 as storage units. A storage device such as a solid-state drive (SSD) may be used instead of the hard disk drive 27. These constituents are connected to an internal bus 28.

A program for performing automated driving control of the automated driving vehicle 10 is stored in at least one of the ROM 25 and the hard disk drive 27 which are the storage devices. By causing the CPU 22 or the like of the control unit 20 to execute the program, functional blocks illustrated in FIG. 2 are formed in the control unit 20. That is, the control unit 20 includes a scan data analyzing unit 40, a self-position estimating unit 41, an autonomous travel control unit 42, a transceiver unit 43, a passenger ascertaining unit 45, a map storage unit 46, a vehicle allocation reservation storage unit 47, and a timepiece 48 as functional blocks.

The scan data analyzing unit 40 is configured to be able to perform recognition of attributes of a nearby object of the host vehicle and measurement of a distance to the nearby object. The scan data analyzing unit 40 acquires a captured image captured by the outside camera 11A. The scan data analyzing unit 40 performs image recognition on the acquired captured image using a single shot multi-box detector (SSD) using supervised learning or a known deep learning method such as You-Only-Look-Once (YOLO). Detection of an object in the captured image and recognition of attributes (such as a vehicle, a pedestrian, or a structure) of the object are performed through the image recognition.

The scan data analyzing unit 40 acquires three-dimensional point group data from the LiDAR unit 11B. The scan data analyzing unit 40 performs clustering of dividing the three-dimensional point group into a plurality of clusters. The scan data analyzing unit 40 prepares periphery data in which the captured image subjected to the image recognition and coordinates of the clustered three-dimensional point group data are superimposed. The distances of objects having certain attributes from the automated driving vehicle 10 can be detected based on the periphery data. The periphery data is transmitted to the self-position estimating unit 41 and the autonomous travel control unit 42.

As will be described later, the scan data analyzing unit 40 recognizes a face of a passenger based on a face image of the passenger set in a reservation for vehicle allocation. For example, the scan data analyzing unit 40 includes a face image database in which a plurality of face images is stored. Face image data of passengers are also stored in the face image database. The scan data analyzing unit 40 is configured to be able to extract a face image from the captured image captured by the outside camera 11A and to extract face information with the highest similarity to the extracted face image from the face image database.

The self-position estimating unit 41 acquires self-position information (latitude and longitude) from the positioning unit 13. For example, the self-position estimating unit 41 acquires self-position information from satellites. It is known that self-position information acquired from satellites includes an error of about maximum 100 m. Therefore, the self-position estimating unit 41 may correct the self-position information acquired from the positioning unit 13.

For example, the self-position estimating unit 41 estimates a rough self-position from the self-position information acquired from the satellites and extracts dynamic map data near the self-position from the map storage unit 46. The self-position estimating unit 41 performs matching the periphery image from the scan data analyzing unit 40 with the three-dimensional image based on the dynamic map. A coordinate point on the dynamic map, that is, the self-position, is acquired through this matching. The acquired self-position information (vehicle position information) is sent to the autonomous travel control unit 42.

The transceiver unit 43 serves as an receiver unit that receives a signal sent from the outside to the automated driving vehicle 10 and a transmitter unit that transmits a signal from the automated driving vehicle 10 to the outside together. For example, travel route map data and travel schedule data are transmitted from the vehicle allocation management device 50 to the transceiver unit 43. As will be described later, the travel route map data includes dynamic map data and is transmitted from the map preparing unit 63 of the vehicle allocation management device 50. The travel schedule data includes a departure time, a target boarding point arrival time, and a target destination arrival time.

The autonomous travel control unit 42 is configured to able to control the steering mechanism 15, the brake mechanism 14, and the inverter 18 which is the drive mechanism based on predetermined travel route information and attributes and a distance of a nearby object which have been analyzed by the scan data analyzing unit 40.

Specifically, the autonomous travel control unit 42 performs travel control of the automated driving vehicle 10 based on the travel route map data stored in the map storage unit 46, the travel schedule data stored in the vehicle allocation reservation storage unit 47, the self-position information (vehicle position information) transmitted from the self-position estimating unit 41, and the periphery data transmitted from the scan data analyzing unit 40.

For example, a global route is determined based on the vehicle position and the travel route map data. A local route in which an obstacle ahead is avoided or the like is determined based on the periphery data. The autonomous travel control unit 42 controls the brake mechanism 14, the steering mechanism 15, and the inverter 18 according to the determined routes.

Vehicle allocation reservation data illustrated in FIG. 4 is stored in the vehicle allocation reservation storage unit 47. All the vehicle allocation reservation data received by the vehicle allocation management device 50 is illustrated in FIG. 4, and only vehicle allocation reservation data in which the vehicle is designated as an allocated vehicle is stored in the vehicle allocation reservation storage unit 47 of the automated driving vehicle 10.

As will be described later, the passenger ascertaining unit 45 determines whether the scan data analyzing unit 40 has recognized a passenger at the boarding point. In at least one of the following cases of (1) to (3), the passenger ascertaining unit 45 transmits a notification to the terminal device 70 which is an interested person's contact-number device set in the reservation for vehicle allocation via the transceiver unit 43:

(1) a case in which a passenger set in a reservation for vehicle allocation has boarded at a boarding point set in the reservation for vehicle allocation;

(2) a case in which a passenger has not been recognized by the scan data analyzing unit 40 within a predetermined waiting time from a target boarding point arrival time set in a reservation for vehicle allocation; and

(3) a case in which a passenger has alighted at a destination set in a reservation for vehicle allocation.

In the case of (2), that is, when a passenger has not been recognized at the boarding point by the scan data analyzing unit 40, the passenger ascertaining unit 45 transmits an absence notification to the terminal device 70 (the interested person's contact-number device) to request a remote operation of the outside camera 11A.

When the passenger's face is recognized by the scan data analyzing unit 40, the passenger ascertaining unit 45 performs displaying a pickup message using the outside noticeboard 90 (see FIG. 5) or outputting pickup voice using the outside speaker 19 to attract the passenger's attention to the automated driving vehicle 10.

Terminal Device

Referring to FIG. 1, the terminal device 70 is a communication terminal device which is owned by a user of the unmanned taxi service using automated driving vehicles 10. The terminal device 70 may be, for example, a smartphone.

A hardware configuration of the terminal device 70 is illustrated in FIG. 1. The terminal device 70 includes an input/output controller 71, a CPU 72, an input unit 73, a display unit 74, and a calling unit 78. The terminal device 70 includes a ROM 75, a RAM 76, and a storage device 77 as storage units. These constituents are connected to an internal bus 79.

The input unit 73 and the display unit 74 may be integrally formed as a touch panel. As will be described later, the input unit 73 can input a destination, a boarding point, a date of use, and a scheduled boarding time (a target boarding point arrival time) in a reservation for vehicle allocation of an automated driving vehicle 10.

A program for performing a reservation for vehicle allocation of an automated driving vehicle 10 is stored in at least one of the ROM 75 and the storage device 77 which are storage devices. By causing the CPU 72 or the like of the terminal device 70 to execute the program, the functional blocks illustrated in FIG. 2 are formed in the terminal device 70. By causing the CPU 72 to execute the program stored in a non-transitory computer-readable storage medium such as a DVD, the functional blocks illustrated in FIG. 2 can also be formed. That is, the terminal device 70 includes a transceiver unit 80 and an unmanned taxi application 82 as functional blocks.

The unmanned taxi application 82 includes a display control unit 82A, a vehicle allocation reservation setting unit 82B, a remote camera operating unit 82C, and a remote speaker operating unit 82D. When the unmanned taxi application 82 is started, an authentication screen is displayed on the display unit 74. When a user account name and a password are input to the screen by a user, for example, using the input unit 73, the unmanned taxi application 82 logs in on a vehicle allocation reservation system.

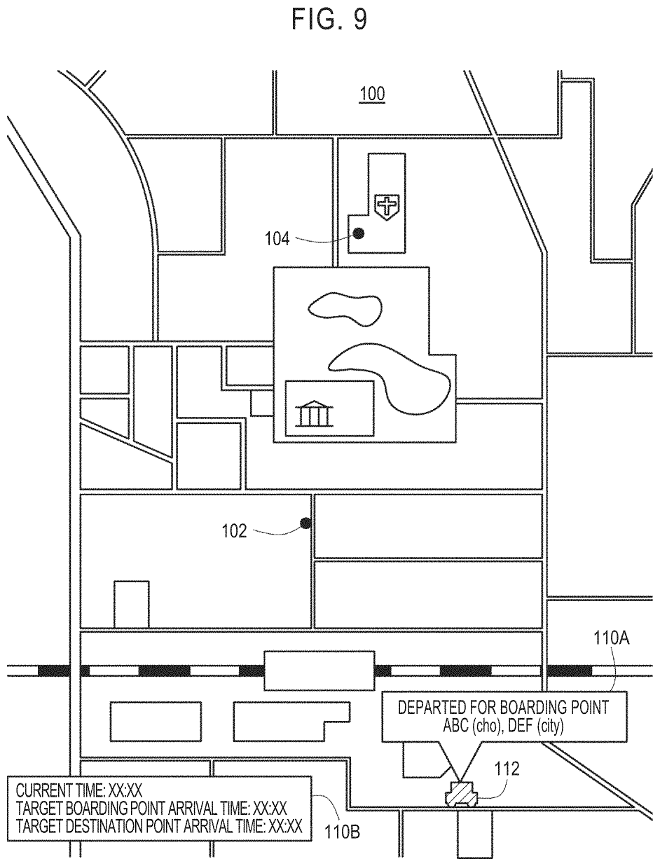

For example, the display control unit 82A displays a vehicle allocation reservation screen including the authentication image on the display unit 74. The display control unit 82A displays guidance screens illustrated in FIGS. 9 to 15 on the display unit 74 at the time of pickup using an automated driving vehicle 10.

The vehicle allocation reservation setting unit 82B sets a reservation for vehicle allocation of an automated driving vehicle which is an unmanned taxi. For example, the vehicle allocation reservation setting unit 82B causes the display control unit 82A to display a vehicle allocation reservation screen on the display unit 74, and allows a user to input entries required for a reservation for vehicle allocation, which are illustrated in FIG. 4. The input entries are transmitted to the vehicle allocation managing unit 61 of the vehicle allocation management device 50.

When a passenger has not been recognized by the scan data analyzing unit 40 of the automated driving vehicle 10 at the time of pickup (when the passenger is absent) as will be escribed later, the remote camera operating unit 82C is configured to remotely operate the outside camera 11A. The remote speaker operating unit 82D is configured to transmit voice data such as natural voice of an interested person input to the calling unit 78 to the passenger ascertaining unit 45 when the passenger is absent. The passenger ascertaining unit 45 outputs the received voice data from the outside speaker 19.

### Vehicle Allocation Managing Routine

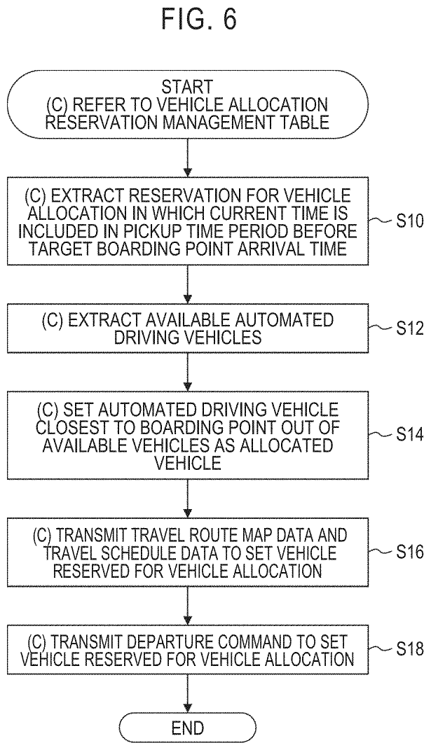

FIG. 6 illustrates a vehicle allocation managing routine which is performed by the vehicle allocation management device 50. This routine is repeatedly performed at predetermined time intervals (for example, 10 minutes). This time interval is shorter than a time (for example, 1 hour) designated in a pickup time period which will be described later. In FIGS. 6 to 8, entities for performing the steps are illustrated. Specifically, steps which are performed by the vehicle allocation management device 50 are denoted by (C), steps which are performed by the automated driving vehicle 10 are denoted by (V), and steps which are performed by the terminal device 70 are denoted by (U).

The vehicle allocation managing unit 61 refers to a vehicle allocation reservation management table stored in the vehicle allocation reservation storage unit 68. The vehicle allocation managing unit 61 refers to the current time from the timepiece 65. The vehicle allocation managing unit 61 extracts a reservation for vehicle allocation in which the current time is included in a pickup time period before the target boarding point arrival time set in the vehicle allocation reservation management table (hereinafter appropriately referred to as a previous reservation for vehicle allocation) (S10). The pickup time period may be, for example, 1 hour before the target boarding point arrival time set in the previous reservation for vehicle allocation.

The vehicle allocation managing unit 61 accesses the automated driving vehicle storage unit 69, ascertains an operating state of each automated driving vehicle 10 under management (in pickup, occupied, or available), and extracts available automated driving vehicles 10 (S12). The vehicle allocation managing unit 61 sets an automated driving vehicle 10 closest to the boarding point set in the previous reservation for vehicle allocation out of the available automated driving vehicles 10 as an allocated vehicle (S14).

Then, the map preparing unit 63 prepares travel route map data passing through three points including the current position of the automated driving vehicle 10 set as an allocated vehicle and a boarding point and a destination which are set in the previous reservation for vehicle allocation. This map data is prepared by processing the dynamic map data stored in the dynamic map storage unit 66.

The vehicle allocation managing unit 61 transmits the travel route map data and travel schedule data to the automated driving vehicle 10 set as an allocated vehicle (S16). The travel schedule data includes the target boding point arrival time set in the previous reservation for vehicle allocation and a target destination arrival time when the automated driving vehicle 10 would travel to the destination at a predetermined rated speed at the target boarding point arrival time. The vehicle allocation managing unit 61 transmits a departure command to the automated driving vehicle 10 set as an allocated vehicle (S18).

### Pickup Routine

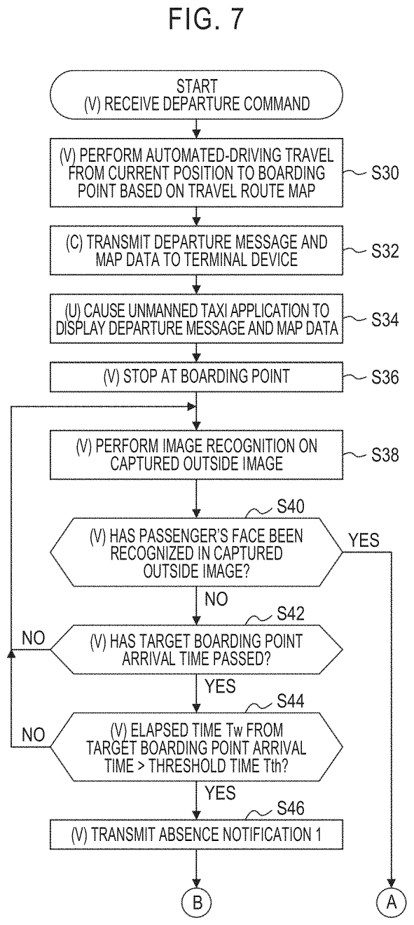

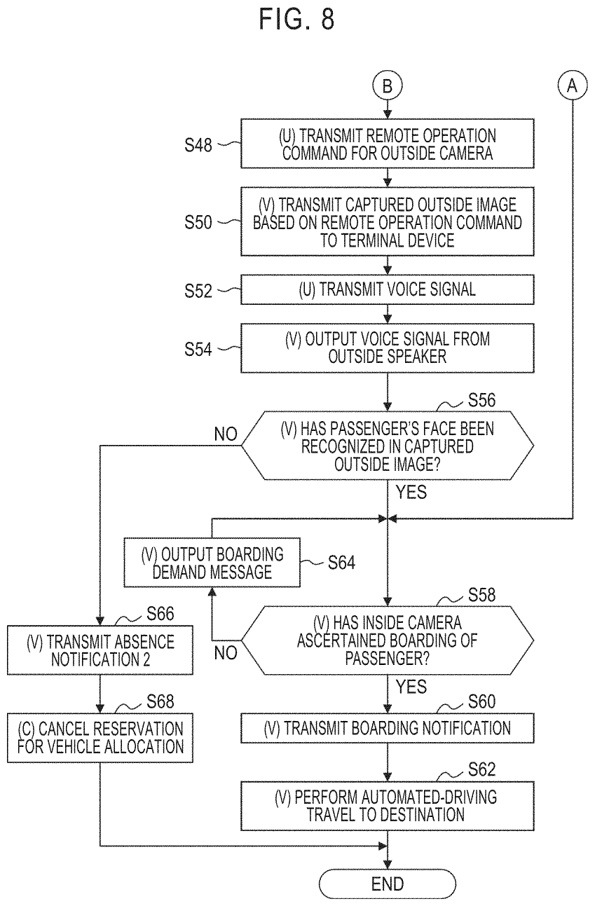

A pickup routine to a boarding point which is performed by an automated driving vehicle 10 set as an allocated vehicle is illustrated in FIGS. 7 and 8. When the pickup routine is performed, the guidance screens illustrated in FIGS. 9 to 15 are displayed on the display unit 74 of the terminal device 70 which is an interested person's contact-number device.

As described above, the automated driving vehicle 10 receives a departure command from the vehicle allocation managing unit 61 of the vehicle allocation management device 50. The autonomous travel control unit 42 of the automated driving vehicle 10 having received the departure command performs automated-driving travel from the current position to the boarding point along the travel route map while controlling the brake mechanism 14, the steering mechanism 15, and the inverter 18 which is a drive mechanism (S30).

The vehicle allocation managing unit 61 of the vehicle allocation management device 50 refers to the vehicle allocation management table (see FIG. 4) stored in the vehicle allocation reservation storage unit 68 (see FIG. 2). Specifically, a user account name set in the reservation for vehicle allocation in which the automated driving vehicle 10 is performing pickup is acquired with reference to the reservation for vehicle allocation in the table.

The vehicle allocation managing unit 61 acquires a user terminal identification symbol correlated with the acquired user account name with reference to the user registration information management table (see FIG. 3) stored in the user registration information storage unit 67. The vehicle allocation managing unit 61 accesses a terminal device 70 which is an interested person's contact-number device with the acquired user terminal identification symbol via the Internet 95.

The vehicle allocation managing unit 61 transmits map image data and departure message data to the terminal device 70 (S32). The display control unit 82A of the terminal device 70 displays the transmitted data on the display unit 74 (S34).

For example, as illustrated in FIG. 9, a map image 100 is displayed on the display unit 74. A boarding point mark 102, a destination mark 104, and an allocated vehicle mark 112 are displayed in the map image 100. A message box 110A in which a departure message indicating that the automated driving vehicle 10 has departed from a boarding point is described and a message box 110B in which a current time, a target boarding point arrival time, and a target destination arrival time are described are displayed in the map image 100.

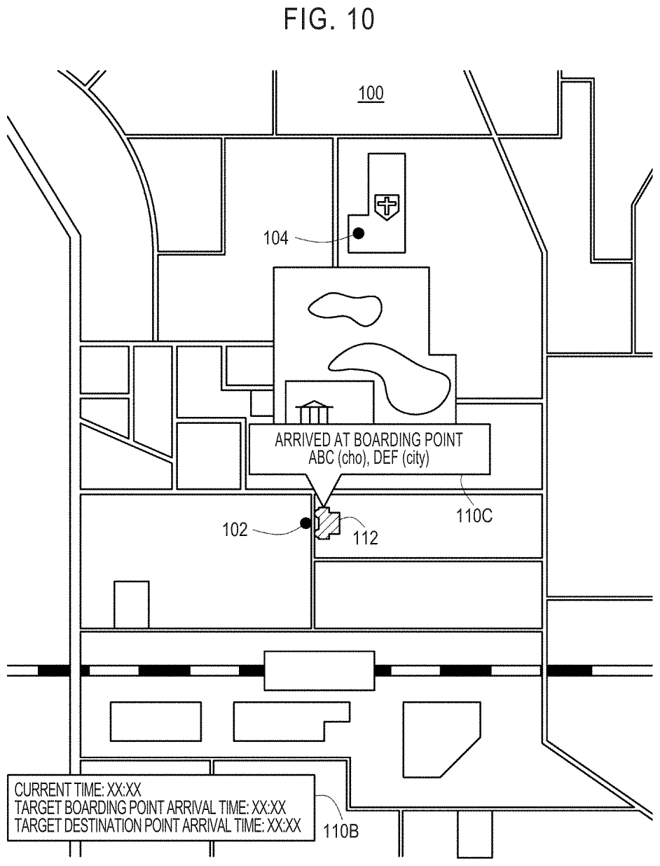

When the automated driving vehicle 10 arrives at the boarding point, the autonomous travel control unit 42 controls the brake mechanism 14 and the inverter 18 such that the automated driving vehicle 10 stops at that position (S36). The vehicle allocation managing unit 61 transmits a notification indicating that the allocated vehicle has arrived at the boarding point to the terminal device 70. As illustrated in FIG. 10, a message box 110C in which a message indicating that the automated driving vehicle 10 has arrived at the boarding point is described is displayed on the display unit 74 of the terminal device 70 having the notification.

The scan data analyzing unit 40 acquires a captured image of the periphery of the automated driving vehicle 10 from the outside camera 11A and performs image recognition (S38). An image recognition result from the scan data analyzing unit 40 is transmitted to the passenger ascertaining unit 45. The passenger ascertaining unit 45 determines whether a passenger is included in attributes of an object recognized by the scan data analyzing unit 40, that is, whether the scan data analyzing unit 40 has recognized the passenger's face in the captured outside image (S40).

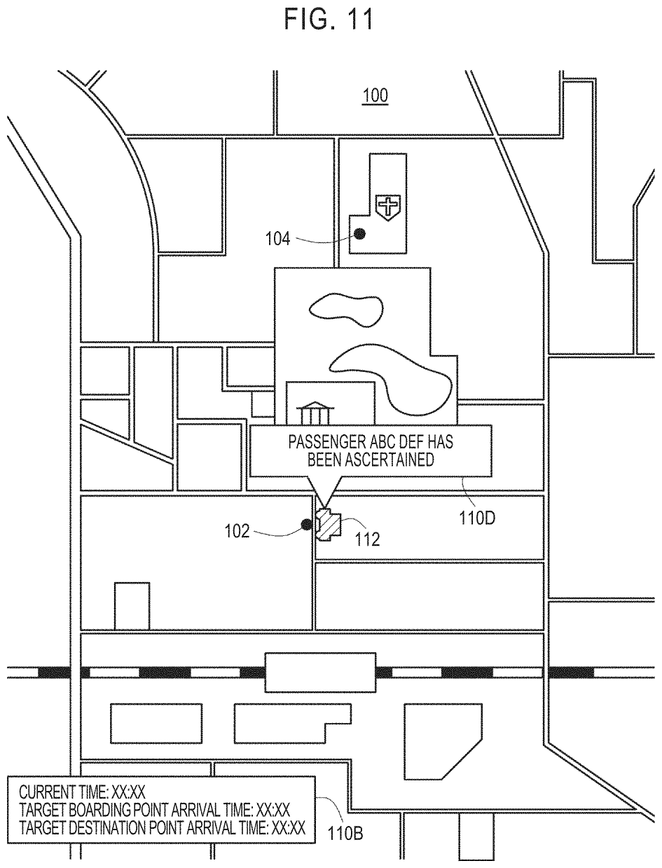

When the scan data analyzing unit 40 has recognized the passenger's face in the captured outside image, the passenger ascertaining unit 45 transmits a notification indicating that recognition of the passenger is successful to the terminal device 70. A message box 110D illustrated in FIG. 11 is displayed in the map image 100 on the display unit 74 of the terminal device 70 having received the notification. A message indicating that the automated driving vehicle 10 could recognize the passenger is described in the message box 110D.

The passenger ascertaining unit 45 ascertains whether the passenger has boarded the vehicle. Specifically, as illustrated in FIG. 8, the passenger ascertaining unit 45 causes the scan data analyzing unit 40 to analyze a captured image from the inside camera 29 and determines whether the passenger could be recognized in the captured image (S58).

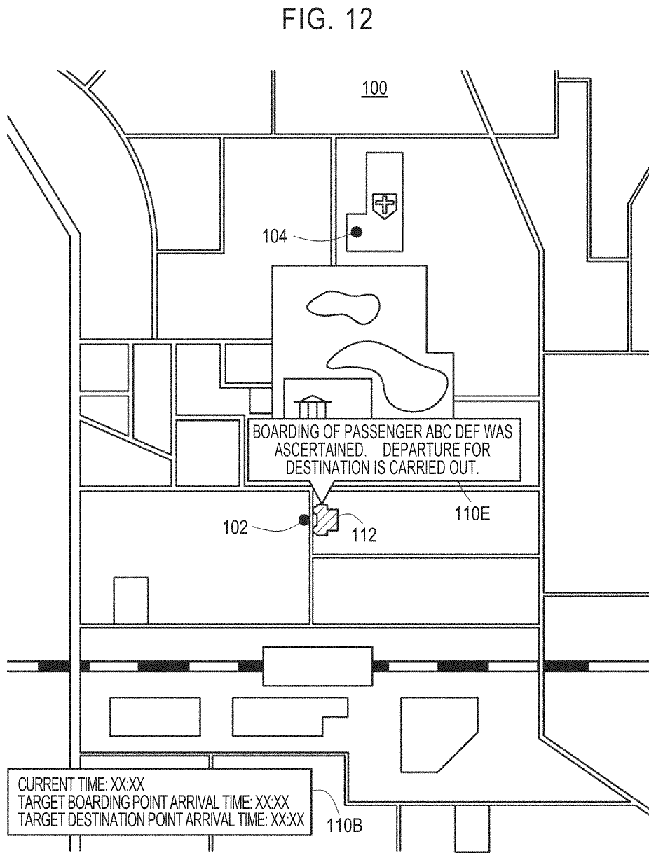

When the passenger has not been recognized from the captured inside image, the passenger ascertaining unit 45 outputs a boarding demand message using at least one of the outside noticeboard 90 (see FIG. 5) and the outside speaker 19 (S64). When the passenger is urged by this message and boards the automated driving vehicle 10, the passenger ascertaining unit 45 transmits a boarding notification to the terminal device 70 which is an interested person's contact-number device (S60). For example, as illustrated in FIG. 12, a message box 110E in which a message indicating that it has been ascertained that the passenger has boarded the vehicle is described is displayed on the terminal device 70. The automated driving vehicle 10 travels to the destination by automated driving (S62).

Although not included in the routines illustrated in FIGS. 7 and 8, the passenger ascertaining unit 45 transmits an arrival notification to the terminal device 70 which is an interested person's contact-number device when the automated driving vehicle 10 has arrived at the destination and the scan data analyzing unit 40 has ascertained that the passenger has alighted based on a captured image from the inside camera 29.

When the scan data analyzing unit 40 has not recognized the passenger's face from the captured outside image in Step S40, the passenger ascertaining unit 45 determines whether the current time is past the target boarding point arrival time set in the reservation for vehicle allocation with reference to the timepiece 48 (S42). When the current time is not past the target boarding point arrival time, there is a likelihood that the passenger would have not reached the boarding point, and thus the scan data analyzing unit 40 continues to perform image recognition on a captured outside image in Step S38.

On the other hand, when the current time is past the target boarding point arrival time, the passenger ascertaining unit 45 calculates an elapsed time Tw from the target boarding point arrival time and determines whether the elapsed time is greater than a predetermined threshold time Tth (waiting time) (S44). The threshold time Tth may be, for example, 10 minutes. When the elapsed time Tw from the target boarding point arrival time is equal to or less than the threshold time Tth, the scan data analyzing unit 40 continues to perform image recognition on a captured outside image in S38.

On the other hand, when the elapsed time Tw from the target boarding point arrival time is greater than the threshold time Tth (waiting time), the passenger ascertaining unit 45 transmits data of absence notification 1 to the terminal device 70 (S46). The passenger ascertaining unit 45 transmits a captured image from the outside camera 11A to the terminal device 70.

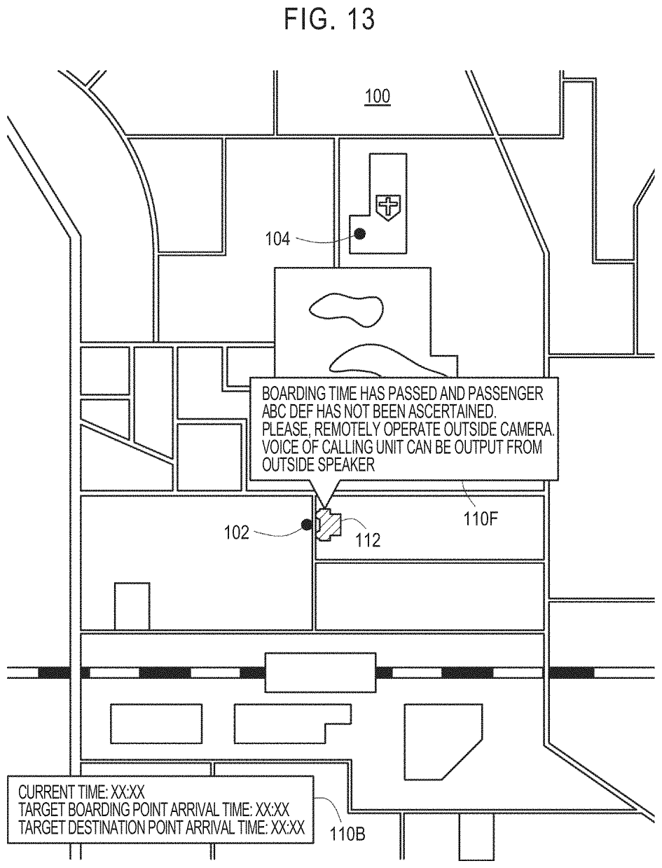

When the transceiver unit 80 of the terminal device 70 receives the data of absence notification 1, a message box 110F in which absence notification 1 indicating that the automated driving vehicle 10 has not ascertained (recognized) the passenger is described is displayed in the map image 100 on the display unit 74 as illustrated in FIG. 13.

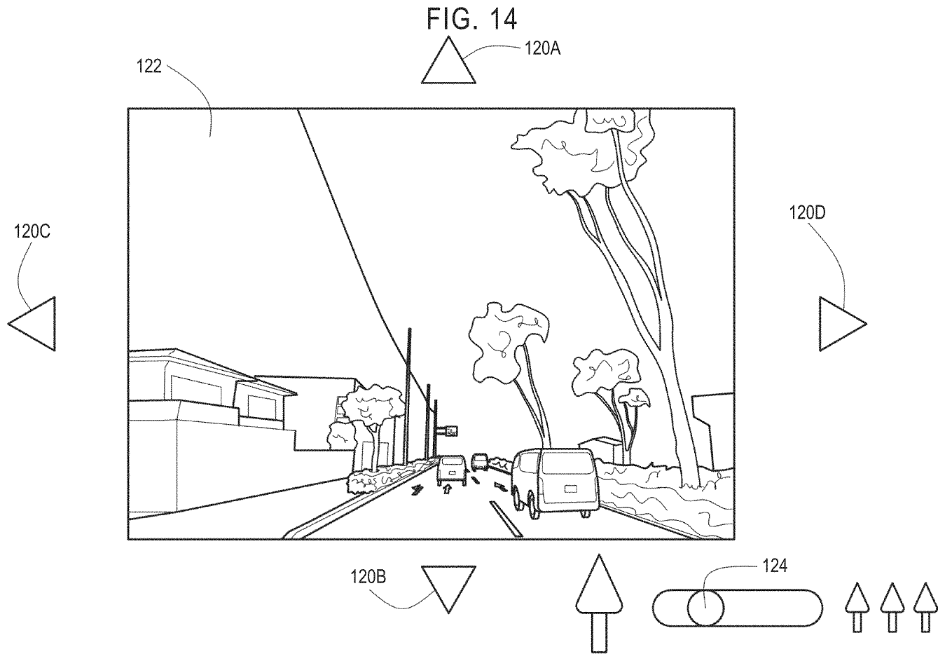

A message for demanding a remote operation of the outside camera 11A and a message indicating that voice of the calling unit 78 can be output from the outside speaker 19 are also described in the message box 110F. The display unit 74 is switched to, for example, a remote operation screen illustrated in FIG. 14. In the remote operation screen, a periphery image 122 of the automated driving vehicle 10 captured by the outside camera 11A which is a captured image received by the transceiver unit 80 is displayed in the remote operation screen.

Operation buttons 120A to 120D for changing a display position and a zoom button 124 for changing an imaging magnification are displayed in the remote operation screen. These buttons are operated by a user via the remote camera operating unit 82C. Imaging settings of the outside camera 11A are changed in accordance with an operation command input by the user (S48). The captured image after the settings have been changed is transmitted from the passenger ascertaining unit 45 to the terminal device 70 (S50).

For example, when the passenger faces a direction different from that in the face image set at the time of reservation for vehicle allocation, it may be difficult for the scan data analyzing unit 40 to recognize a face. When the passenger is apart from the automated driving vehicle 10, it may be difficult to analyze features of a face.

In this case, an interested person of the passenger may be able to recognize the passenger, for example, based on features such as the clothes or height of the passenger. Therefore, a user is allowed to remotely operate the outside camera 11A and settings such as a magnification or an imaging angle (a camera angle) are changed such that the face of the passenger can be recognized.

When the user speaks to the calling unit 78 of the terminal device 70, the calling unit 78 transmits voice data to the passenger ascertaining unit 45 (S52). The passenger ascertaining unit 45 outputs the received voice data from the outside speaker 19 (S54). When voice which has been heard by the passenger is output from the outside speaker 19, attraction of attention such as turning of the passenger's face to the automated driving vehicle 10 may be possible and thus it may be possible to easily recognize the face. Steps S48 to S54 may be repeatedly performed within a predetermined time.

The passenger ascertaining unit 45 determines whether the scan data analyzing unit 40 has recognized the passenger's face from the captured outside image (S56). When the passenger's face has been recognized, the routine proceeds to Step S58 in which it is ascertained whether the passenger boards the automated driving vehicle 10.

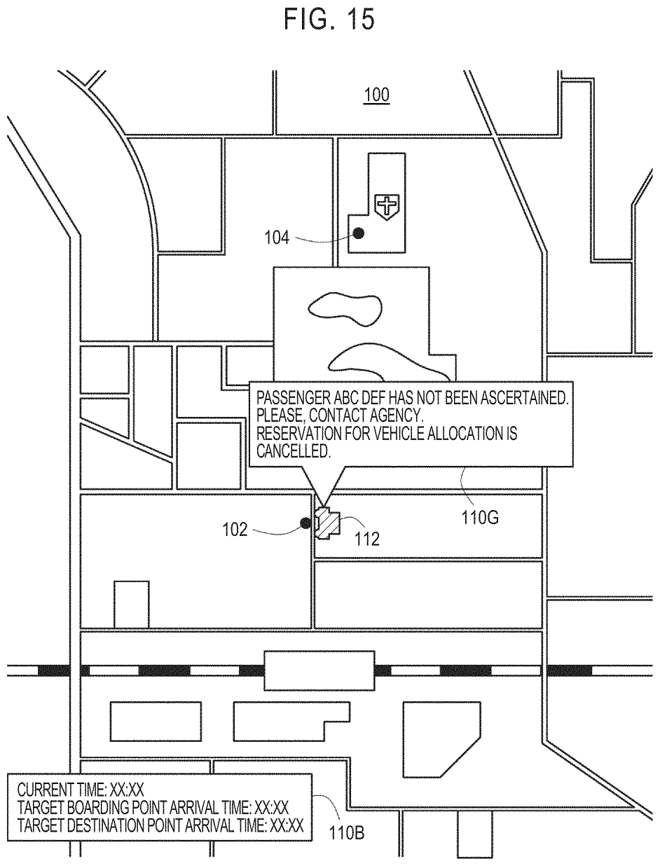

On the other hand, when the scan data analyzing unit 40 could not recognize the passenger's face from the captured outside image in Step S56, the passenger ascertaining unit 45 transmits data of absence notification 2 to the terminal device 70 (S66). As illustrated in FIG. 15, a message box 110G in which absence notification 2 indicating that the automated driving vehicle 10 could not ascertain (recognize) the passenger is described is displayed in the map image 100 on the display unit 74 of the terminal device 70.

A message for demanding contact to a relevant such as the police or a facility for aged people or a message indicating that the reservation for vehicle allocation is cancelled is also described in the message box 110G. The passenger ascertaining unit 45 cancels the reservation for vehicle allocation (S68). For example, the passenger ascertaining unit 45 transmits a notification indicating that the passenger could not be recognized even by the user's remote operation and a notification for cancelling the reservation for vehicle allocation to the vehicle allocation managing unit 61 of the vehicle allocation management device 50. The vehicle allocation managing unit 61 having received the notifications cancels the corresponding reservation for vehicle allocation in the vehicle allocation reservation management table (see FIG. 4) (S68).

In the aforementioned embodiment, the passenger ascertaining unit 45 transmits a notification to the terminal device 70 in all the case in which the passenger boards an automated driving vehicle 10, the case in which the passenger alights from the automated driving vehicle 10, and the case in which the passenger is absent at the boarding point, but the notification may be transmitted in only one of the three cases. For example, the passenger ascertaining unit 45 may perform S46 (transmission of absence notification 1) in FIG. 7, skip S60 (transmission of a boarding notification) in FIG. 8, and skip notification at the time of alighting.

### Another Example of Vehicle Allocation System

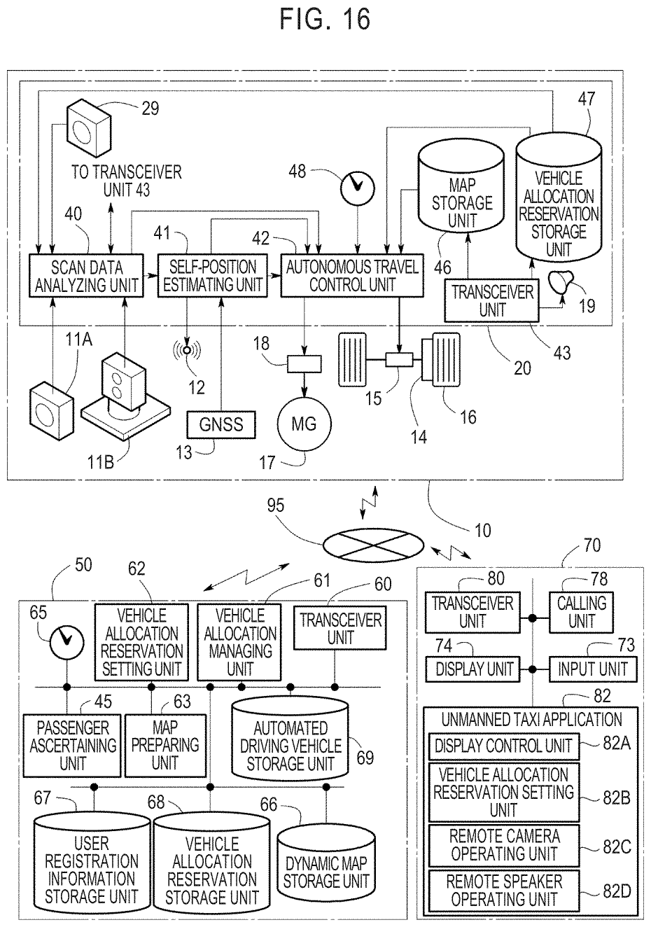

FIG. 16 illustrates another example of the vehicle allocation system according to the embodiment. This example is different from the example illustrated in FIG. 2 in that the passenger ascertaining unit 45 is transferred from the automated driving vehicle 10 to the vehicle allocation management device 50. That is, in this embodiment, measures in the cases in which a passenger boards, alights, and is absent are taken by the vehicle allocation management device 50.

That is, the passenger ascertaining unit 45 provided in the vehicle allocation management device 50 transmits a notification to a terminal device 70 which is an interested person's contact-number device set in a reservation for vehicle allocation in at least one of:

(1) a case in which a passenger set in the reservation for vehicle allocation has boarded at a boarding point set in the reservation for vehicle allocation;

(2) a case in which the passenger has not been recognized by the scan data analyzing unit 40 within a predetermined waiting time from a target boarding point arrival time set in the reservation for vehicle allocation; and

(3) a case in which the passenger has alighted at a destination set in the reservation for vehicle allocation.

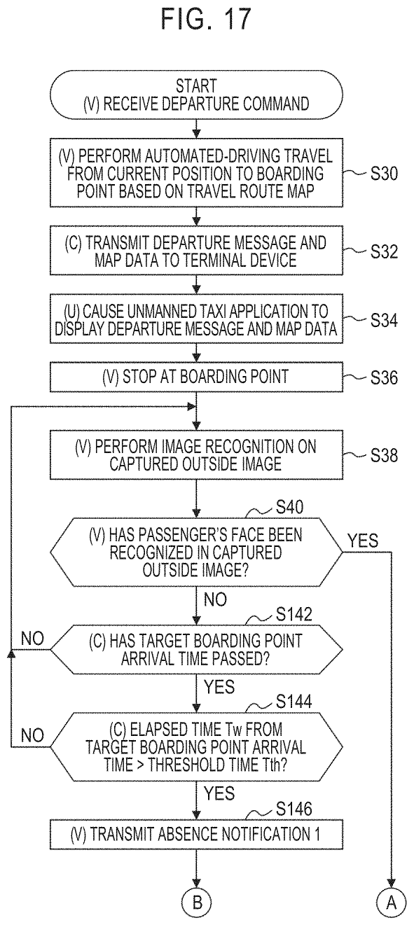

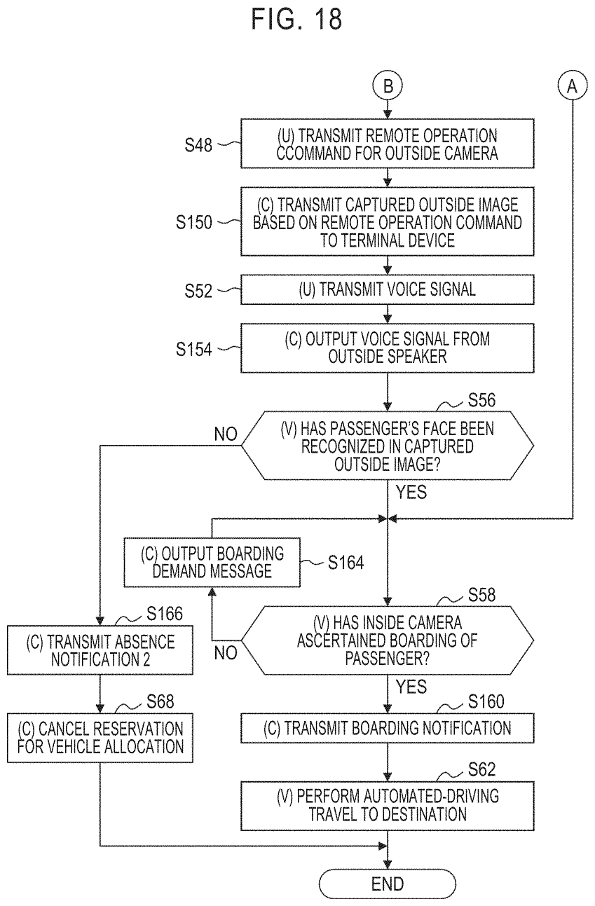

Specifically, a pickup routine which is performed by the vehicle allocation system illustrated in FIG. 16 is illustrated in FIGS. 17 and 18. In this routine, Steps S42, S44, S46, S50, S54, S60, S64, and S66 which are performed by an automated driving vehicle 10 in FIGS. 7 and 8 are replaced with Steps S142, S144, S146, S150, S154, S160, S164, and S166 which are performed by the vehicle allocation management device 50. Processing details of the steps including the steps referred to by the same step numbers as illustrated in FIGS. 17 and 18 are the same as in the routine illustrated in FIGS. 7 and 8.

As can be clearly seen from the routine illustrated in FIGS. 17 and 18, the passenger ascertaining unit 45 of the vehicle allocation management device 50 transmits a boarding notification to the terminal device 70 (S160) when a passenger has boarded the automated driving vehicle 10 at a boarding point (YES in S58). When the passenger has not been recognized by the scan data analyzing unit 40 within a predetermined threshold time Tth from a target boarding point arrival time (YES in S144), the passenger ascertaining unit 45 of the vehicle allocation management device 50 transmits absence notification 1 and a captured image captured by the outside camera 11A to the terminal device 70 (S146). Absence notification 1 includes a message for demanding an input of an operation command for the outside camera 11A from the terminal device 70.

Although not included in the routines illustrated in FIGS. 17 and 18, the passenger ascertaining unit 45 of the vehicle allocation management device 50 transmits an arrival notification to the terminal device 70 which is an interested person's contact-number device when the passenger has alighted from the automated driving vehicle 10 at the destination. Specifically, when the scan data analyzing unit 40 has ascertained that the passenger has alighted based on a captured image of the inside camera 29, an alighting notification is transmitted to the vehicle allocation management device 50 via the transceiver unit 43. The passenger ascertaining unit 45 of the vehicle allocation management device 50 having received the alighting notification transmits an arrival notification to the terminal device 70.

In the aforementioned embodiment, the passenger ascertaining unit 45 of the vehicle allocation management device 50 transmits a notification to the terminal device 70 in all the case in which the passenger boards an automated driving vehicle 10, the case in which the passenger alights from the automated driving vehicle 10, and the case in which the passenger is absent at the boarding point, but the notification may be transmitted in only one of the three cases. For example, the passenger ascertaining unit 45 may perform S146 (transmission of absence notification 1) in FIG. 17, skip S160 (transmission of a boarding notification) in FIG. 18, and skip notification at the time of alighting.

What is claimed is:

1. An automated driving vehicle comprising:
an analysis unit configured to be able to perform attribute recognition and distance measurement of a nearby object of a host vehicle;
an autonomous travel control unit configured to be able to autonomously control a steering mechanism, a brake mechanism, and a drive mechanism based on predetermined travel route information and the attributes and distance of the nearby object; and
a passenger ascertaining unit configured to transmit a notification to an interested person's contact-number device set in a reservation for vehicle allocation in at least one of (1) a case in which a passenger set in the reservation for vehicle allocation has boarded at a boarding point set in the reservation for vehicle allocation, (2) a case in which the passenger has not been recognized by the analysis unit within a predetermined waiting time from a target boarding point arrival time set in the reservation for vehicle allocation, and (3) a case in which the passenger has alighted at a destination set in the reservation for vehicle allocation.

2. The automated driving vehicle according to claim 1, further comprising an imaging device that images the periphery of the automated driving vehicle and transmits a captured image to the analysis unit,
wherein the passenger ascertaining unit is configured to transmit an absence notification as the notification to the interested person's contact-number device and to transmit the captured image in (2) the case in which the passenger has not been recognized by the analysis unit within the predetermined waiting time from the target boarding point arrival time, and
wherein the imaging device is configured to change imaging settings based on an operation command from the interested person's contact-number device having received the absence notification.

3. The automated driving vehicle according to claim 2, wherein the analysis unit is configured to recognize the passenger in the captured image based on a face image of the passenger set in the reservation for vehicle allocation.

4. The automated driving vehicle according to claim 2, further comprising an outside speaker that is able to output voice which is input to a calling unit of the interested person's contact-number device.

5. A vehicle allocation management device comprising:
a vehicle allocating managing unit configured to allocate an automated driving vehicle to a boarding point set in a reservation for vehicle allocation at the time of pickup based on the reservation for vehicle allocation; and
a passenger ascertaining unit configured to transmit a notification to an interested person's contact-number device set in a reservation for vehicle allocation in at least one of (1) a case in which a passenger set in the reservation for vehicle allocation has boarded the automated driving vehicle at the boarding point, (2) a case in which the passenger has not been recognized by the automated driving vehicle within a predetermined waiting time from a target boarding point arrival time set in the reservation for vehicle allocation, and (3) a case in which the passenger has alighted from the automated driving vehicle at a destination set in the reservation for vehicle allocation.

6. The vehicle allocation management device according to claim 5, wherein the passenger ascertaining unit is configured to transmit an absence notification as the notification to the interested person's contact-number device and to transmit an image captured by an imaging device configured to image the periphery of the automated driving vehicle in (2) the case in which the passenger has not been recognized by the automated driving vehicle within the predetermined waiting time from the target boarding point arrival time, and
wherein the absence notification includes a message for demanding an input of an operation command for the imaging device from the interested person's contact-number device.

7. A terminal device comprising:
an input unit configured to be able to receive an input of a reservation for vehicle allocation of an automated driving vehicle, a boarding point, a target boarding point arrival time, and a passenger set in the reservation for vehicle allocation;
a transceiver unit configured to receive an absence notification and an image captured by an imaging device configured to image the periphery of the automated driving vehicle when the passenger has not been recognized at the boarding point by the automated driving vehicle within a predetermined waiting time from the target boarding point arrival time; and
a remote operation unit configured to be able to input an operation command for the imaging device when the absence notification and the captured image are received by the transceiver unit.
